(19) United States
(12) Patent Application Publication
(10) Pub. No.: US 2006/0274721 A1
(43) Pub. Date: Dec. 7, 2006

(54) Delivery of video or voice mail messages over a packet network

(75) Inventor: Thomas F. Flanagan, Springfield, VA (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/141,850

(22) Filed: Jun. 1, 2005

(51) Int. Cl. H04L 12/66

(52) U.S. Cl. 370/352

(57) ABSTRACT

The invention provides a method and system to create and stores multi-media messages for delivery over a packet network. When a real-time media path over a packet network between two IP phones is unavailable the method monitors the network connection and delivers the recorded message when the media path is available. The invention provides a caller the ability to delivery a message over a packet network to a called party when the called party does not answer an IP phone call and does not have voice mail or video mail capabilities. A caller signals a call agent to record a message and the call agent delivers the message based upon a delivery schedule entered by the caller.

### CROSS-REFERENCE TO RELATED APPLICATIONS

None

### FIELD OF THE INVENTION

The present invention relates to improving voice and video message delivery over a data network. More specifically, the present invention relates to creating, storing, and transmitting voice messages between telephony devices over a packet network.

### BACKGROUND OF THE INVENTION

In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed. Many incumbent local exchange and long-distance service providers use VolP technology in the backhaul of their networks without the end user being aware that VolP is involved.

Quality of service for voice and video transmission on a packet network is traditionally thought of as the end user's perception of quality. Network performance will affect voice quality. However, as VolP technology increases in demand on a network and networks become more complicated with connections through the Internet and PSTN using IP phones (wired and wireless) and residential voice gateways, VolP providers have a much more difficult time assuring the voice quality for their subscribers. Reasons for this include lack of control over the underlying transport network, such as when a service provider providing voice service from a residential gateway attaches to another provider's residential broadband cable modem or DSL (Digital Subscriber Line) service and the use of transport technology that can vary in quality. For example, using WLAN (wireless local area network) media to transport VolP, especially when the wireless end user is moving between WLANs.

An example of networks and components for a VolP call is illustrated in FIG. 1. Access network 10 could be any network accessing the Internet 34 such as a packet network using Internet Protocol (IP), Asynchronous Transfer Mode (ATM), Ethernet network, or other broadband network. Network 10 comprises a router 14 connected to various customer premise equipment and to media gateway 12. Media gateway 12 may be capable of detecting changing resource or network conditions. The ability to detect and monitor changing resource and network conditions can result in significant cost reductions and/or improved quality. Router 14 is connected to Internet Access Device (IAD) 16, wireless access point (AP) 22, and/or IP PBX (personal branch exchange) phone system 26. A voice call may be placed between any of the telephony equipment, including IP phone 18 connected to MG 12, wireless IP phone (WIPP) 24 connected to AP 22, or IP PBX. Using special software, calls could also be placed through computer 20 connected to Internet Access Device (IAD) 16.

Customer equipment is connected through access broadband network 10 to the Internet 28 by media gateway 12. On the far end is the PSTN 46, networking to POTS phone 44 through a Central Office 42. PSTN 46 is also connected to the Internet 28 through a trunk gateway, composed of signal gateway 38, media gateway controller/proxy (MGC) 34, and trunk media gateway (MG) 38. IP and packet data (e.g., real time protocol (RTP packet data)) associated with the call is routed between MG 12 and trunk MG 38. The trunk gateway system provides real-time two-way communications interfaces between the Internet 28 and the PSTN 46. As another example, a VOIP call could be initiated between WIPP 24 and IP phone 32. In this call, voice signals and associated packet data are sent between MG 12 and MG 30 through Internet 28, thereby bypassing the PSTN 46 altogether.

Factors that affect voice quality in a VolP network are fairly well understood. The level of control over these factors will vary from network to network. This is highlighted by the differences between a well-managed small network enterprise verses an unmanaged network such as the Internet. Network operational issues affect network performance and will create conditions that affect voice quality. These issues include outages/failures of network switches, routers, and bridges; outages/failure of VoIP elements such as call servers and gateways; and traffic management during peak periods and virus/denial of service attacks.

A problem occurs in a voice-data network when a call cannot connect between a caller's phone and the called party's phone. The call due to network quality and/or operational issues. This is especially a problem if the call is routed through an unmanaged network, such as the Internet. If a call cannot connect with a receiver due to network problems, then there is no process to leave a message for the receiver using the same network. Another reason a call may not connect is simply because the called party has chosen to make himself unavailable by taking the receiver “off-hook” or by using a presence indicator such as is found in instant messaging systems.

### SUMMARY

The limitations of the prior art are overcome by the present invention's system and method for creating and storing voice and video messages when a real-time media path over a packet network between two IP phones is unavailable, and then connecting with the called party and playing the stored message when the media path is reestablished. A further advantage of the present invention provides a caller the ability to delivery a message to a called party when the called party does not answer a call and the called party does not have voice mail or video mail capabilities. After a pre-programmed number of unanswered rings or equivalent signaling messages, the caller signals a call agent to record a message. The call agent is then programmed to deliver the recorded

### BRIEF DESCRIPTION OF THE DRAWINGS

Preferred embodiments of the invention are discussed hereinafter in reference to the drawings, in which:

FIG. 1 illustrates a network diagram of a voice over packet network;

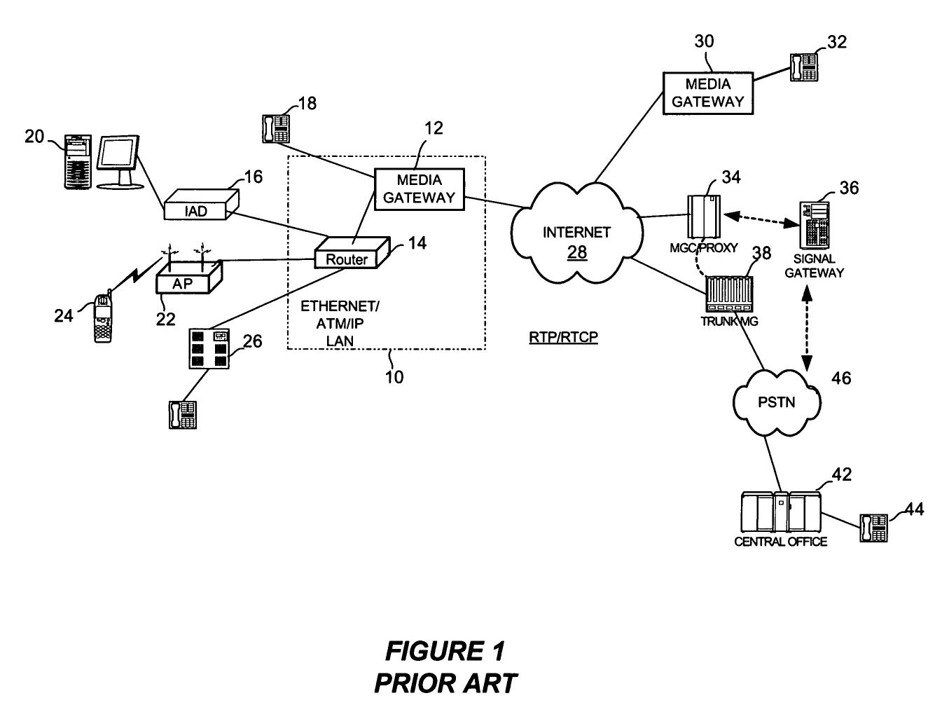

FIG. 2 illustrates a simplified network diagram of a voice over packet network;

FIG. 3 contains a flowchart of the method of the preferred embodiment for an delayed delivery of video or voice mail messages over an IP network;

FIG. 4 contains a flowchart of the method of an alternative embodiment for an automated delivery of video or voice mail messages over a newtork.

### DETAILED DESCRIPTION OF PREFERRED EMBODIMENTS

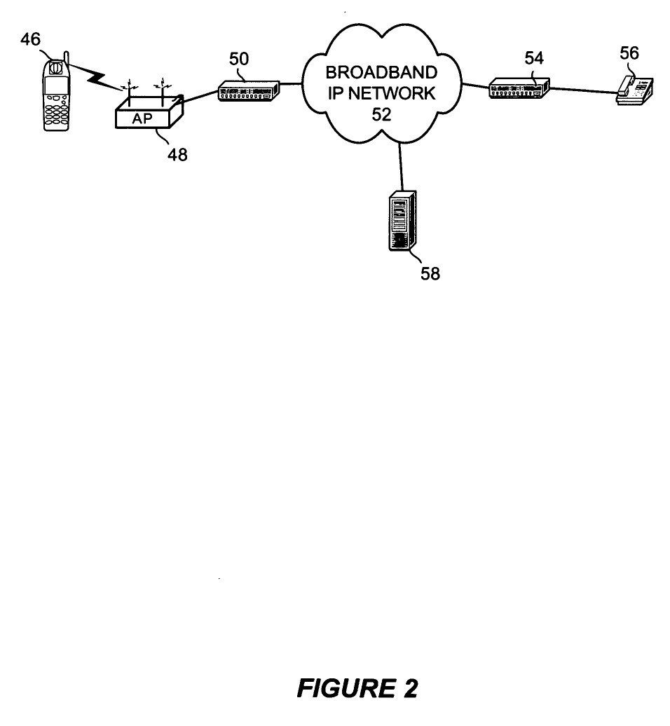

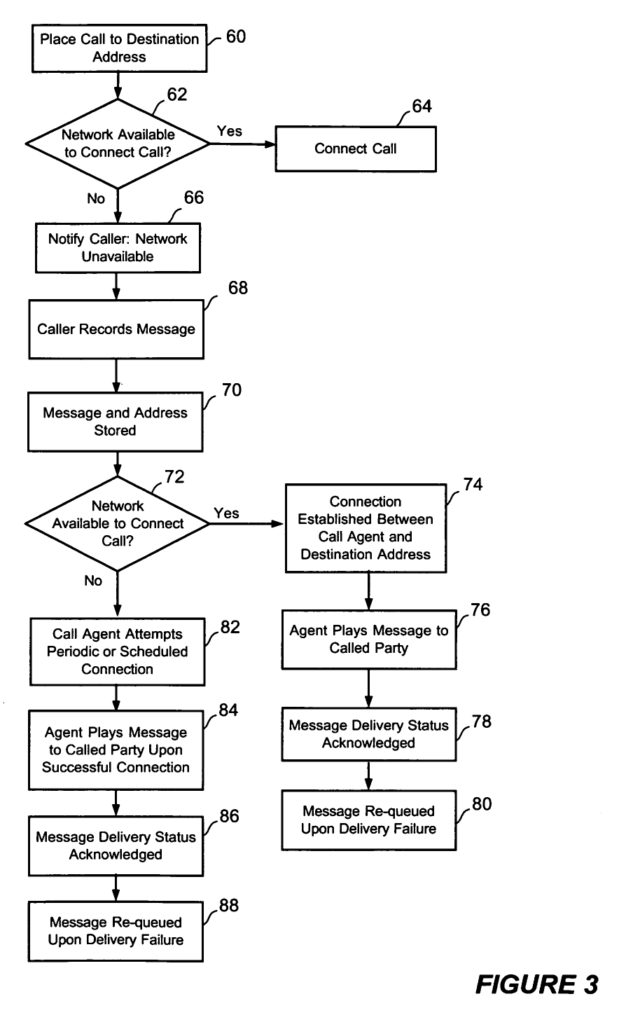

The preferred embodiment of the present invention includes a system and method for creating, storing, and delivered delayed voice messages and video messages over an Internet Protocol (IP) network from a caller's phone to a called party's phone after determining that the network path between the two phones is unavailable. The preferred embodiment is described in relation to the exemplary voice over Internet Protocol (VOIP) network, illustrated in FIG. 2, and with the flowchart featured in FIG. 3.

FIG. 2 illustrates a simplified network diagram that includes wireless IP phone 46 at one end that is connected to IP phone 56 through the network. In addition to voice encoding capability, IP phone 56 also has video recording and encoding capability such that a video with voice recording may be transmitted from IP phone 56 to a far-end receiver or saved for a delayed delivery. IP phone 56 is connected to network 52 through media gateway 54. Although network 52 is identified as a Broadband IP Network in the illustration, it is understood this network could be any type of network capable of transmitting data protocol units containing encoded voice and/or video data. Also connected to IP network 52 through media gateway 50 is wireless IP phone (WIPP) 46. Instead of a hard-wired network IP phone, WIPP transmits packetized data units through a wireless medium to access point (AP), which then connects to MG 50.

The monitoring of network status of a VOIP network configured with the capabilities of the preferred embodiment can be periodic or continuous. Monitoring can be managed from centralized monitoring server 58. Monitoring is performed using methods known in the art of network monitoring and can include monitoring of a single device, such as IP phone 56, a VOIP gateway 54 that attaches directly to network 52 using embedded or external monitoring clients. Monitoring of a network may also be distributed across multiple physical devices (e.g., IP phone, VOIP gateway), IP and/or logical devices (e.g., SIP server, proxy server), network lines and connections, and network levels.

A method of the preferred embodiment is illustrated by the flowchart in FIG. 3. A user at IP phone 56 places a voice or voice and video call 60 over network 52 to IP phone 46. If the network is determined available to connect the call 62, then the call connects manually 64 between the two phones as is known in the art. However, if the network is determined to be unavailable to connect the call 62, the calling party (e.g., the caller) is notified 66 that the network is currently unavailable for the call. Methods for notification include audible signaling tones at the caller's phone or handset, display of textual messages on a Caller-ID or other type of visual display screen, for the phone, or executing a visual indication such as an indicator light that is similar to a message waiting light or call holding light. After notification, the caller is provided with an option of recording a message that would be sent on a delayed delivery schedule. The caller records a message 68, which can be saved into memory either locally on the phone 56 or on a network server 52 that is managed by a call agent. The caller is provided with an option to have the message delivered automatically upon reestablishment of the network connection.

The message recorded by the caller 68 can be recorded in one of a variety of encoding formats that can be either specified as a default for all messages or chosen prior to recording the message. Exemplary encoding formats for voice calls include wave, MP3, and specific codecs such as G.711, G.729, G.723.1, etc., from the International Telecommunications Union (ITU) set of Recommendations. Video messages or text messages may be encoded into their respective formats. The recorded message is then saved and stored in memory 70. The point of saving could be locally in the phone 56, a portion of the network that is accessible such as a local PC, a nework file server, or a PBX voice mail system connected to the phone's local area network. The message could also be saved on a server in broadband network 52.

The agent checks the monitoring system 58 on the broadband network to determine if network 52 is available to connect the call 72. An attempt to establish connection to the called party is performed when the monitoring system determines that the network failure has subsided 74. When the connection is established, the message is played to the called party 76. After the message is successfully delivered, notification of delivery is provided to the caller 78. The called party may then be prompted by the call agent to acknowledge the message. If, during delivery of the message the connection between the delivery source and the called party's phone is interrupted, the message will be re-queued for re-delivery 80. In the case where the message was not completely delivered to the called party, the calling party is notified that either the disconnect was manually performed by the called party or due to network problems. If the called party terminated the reception of the message (thus terminating the automated call) before the entire message was played, then the termination of the call by a manual disconnect would be indicated by a normal disconnect sequence. The agent also determines if the failure to deliver the message was due to further network connection problems. The called party may also purposefully maintain his or her phone off-hook. A presence indicator may be in use at the receiving phone. This present indicator can maintain the phone in an unavailable state via off-hook or equivalent signaling mechanism so that calls and messages cannot connect to the phone. In either case, the messages may be re-queued 80 for future delivery. For example, the agent can query the called party's phone for a presence indication signal, and transmit the message when the called party is present.

If, upon query from the call agent to the monitoring system, that the network continues to respond that the connection to the called phone is unavailable 72 for delivery the message, then the call agent automatically attempts a connection 82 to the called party's phone according to a pre-defined schedule or periodicity. After automatic connection, the agent plays the message 84 to the called party and notifies the caller's phone of the delivery. The agent provides the called party with an option of acknowledging the status of the message delivery, such as whether a full message was delivered or was the message corrupted or unintelligible. If the re-delivery attempt of the message was interrupted or prevented due to network problems then the message is re-queued 88 for further delivery attempts.

The present invention provides an embodiment for transmitting a video message or voice message to an IP phone irregardless of connection problems and interruptions experienced on a packet network such as the Internet. Once a network monitoring system determines that a network connection available between a call agent and a called party's phone, the agent can deliver the message. However, if the called party does not actually answer his or her IP phone when the agent attempts message delivery, and the called phone does not have mail capabilities to save the message, the end result is that the message remains undelivered. Therefore, an alternative embodiment to the present invention provides for automated delivery of video or voice-mail messages over a voice-data network. The method preferably provides the ability to manage outbound messages to allow voice mail, video mail, or electronic text messages to be delivered to a receiving party who is unavailable at the time of the call and does not have a device or service (e.g., voice mail or answering machine) to automatically receive and save the message upon delivery and playout. The method also allows for recording and delivery of a message at some future time after the initial contact attempt fails.

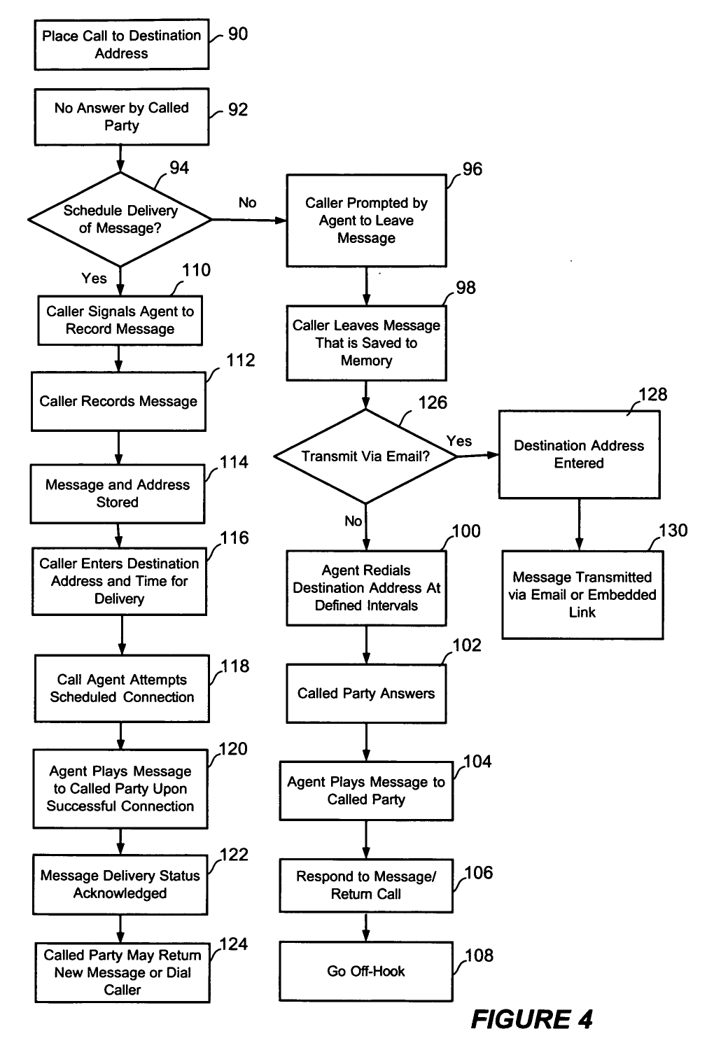

Referring the flowchart in FIG. 4, a method for the alternative embodiment begins with a caller from a first IP phone 56 placing a call to a destination address 90. The call may generally be routed through GW 54, broadband IP network 52, far-end GW 50, and routed wirelessly from AP 48 to the called party at wireless IP phone 46. When no answer is made to the call by the called party after a pre-programmed number of rings 92, the caller is prompted by a call agent to choose a process for sending a message to the unavailable called party. The caller has a choice between one of two methods to save a voice or video message using IP phone 56 for future delivery.

If the caller does not desire a scheduled transmission of a message 94, then after a pre-programmed number of rings or equivalent signaling events, the caller is prompted by the agent to leave a message 96. The caller leaves a message that is recorded and saved to a memory for future delivery 98. The message may be saved locally on phone 56, or on a local or broadband network 52 server. An alternative embodiment provides the caller an option to transmit a locally saved video or voice mail message instantly via an attachment to an email or as a link to a Web site. If the caller desires this mode of message transmission 126, then the caller is prompted to enter the called party's destination email or similar address 128, which may be entered through a phone's keypad or attached computer. After the address is entered, the caller hangs up and the message is transmitted to the receiver 130. Instead of an email attachment, the system could transmit an email or SMS (text) message containing a hyperlink to a Web site address of the saved message in order for the called party to access the saved electronic message file. After the caller completes the message and hangs up, the agent immediately redials the called number 100 at pre-programmed intervals of time or other periodic instances until the called party answers 102. The agent then plays out the message to the called party 104, who then may respond with a message back to the caller or place a call back directly to the caller 106 upon entry of a signal to the call agent. The called party then goes off-hook and hangs up the phone 108.

If the caller desires a message for transmission via scheduled delivery 94, then the caller signals the call agent 110 via a key, key sequence, voice command, or other function such as a network-based message (e.g., from a Web page). The agent proceeds to prompt the caller to leave a message, after which the caller records a message 112. The message may be saved locally on phone 56, or on a local or broadband network 52 server. The caller is then prompted to enter the time and date for desired delivery and destination address of the message 116. If, as an alternative, the caller desires to transmit a message to a called party without first placing a direct call by dialing the destination number as in step 90, then the caller can enter the called party's destination information in step 116 in addition to the time and date of message delivery. Destination information includes the phone number to phone 46, the SIP, URL, email address, etc. of the called party. The message may also be transmitted to multiple parties as a broadcast after entering multiple phone numbers, URLs, etc. for the intended receivers of the message.

At the scheduled future time the agent attempts scheduled delivery of the message 118. If the called party uses a presence indicator, the agent query the receiver's phone until the signal indicates the called party is available and then transmit the message. If no presence indicator is in use, the agent dials the called party's phone when according to the schedule and when the called party answers the phone 46, the agent plays out the message 120. After playout, the agent transmits a message delivery acknowledgment 122 to the caller's phone 56. The called party may respond with a message back to the caller or place a call back directly to the caller, upon entry of a signal to the call agent 124, or simply go off-hook by hanging up the call.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A method for delivery of messages over an packet network, comprising:
monitoring a packet network for network congestion, with a network monitoring system, between a first Internet Protocol (IP) phone, connected to said packet network, and a second IP phone, connected to said network;
attempting a call between a caller on said first IP phone and a called party on said second IP phone;
notifying said caller that said packet network is unavailable to connect said call;
recording a message, from said caller on said first IP phone, for delayed transmission to said second IP phone;
determining a connection on said packet network is available to transmit said recorded message to said second IP phone; and
transmitting said message automatically to said second IP phone when said called party answers said second IP phone.

2. The method of claim 1, wherein said notifying comprises transmitting one of an audible or visual indicator signal to said first IP phone.

3. The method of claim 1, wherein said notifying, said recording, and said transmitting are handled by a call agent.

4. The method of claim 1, wherein said message is one of a voice or video message.

5. The method of claim 3, wherein said handling further comprises receiving data from said monitoring system to said call agent that said packet network is available to place a call between said first IP phone and said second IP phone.

6. The method of claim 1, wherein said dialing further comprises:
playing said message out to said second IP phone upon said called party answering said IP phone; and
notifying said first IP phone of a delivery of said message to said second IP phone.

7. The method of claim 1, wherein said dialing further comprises:
re-dialing said second IP phone for transmission of said message if during playout of said message problems on said packet network prevent a full delivery of said message.

8. The method of claim 1, wherein said transmitting further comprises:
transmitting said message via one of an email message and an embedded hyperlink in a text message.

9. A method for delivery of messages over an packet network, comprising:
attempting a call between a caller on said first Internet Protocol (IP) phone, connected to said packet network, and a called party on a second IP phone, connected to said network;
transmitting a signal to a call agent, from said caller on said first IP phone, to record a message if said called party does not answer said call after a determined number of rings;
recording said message from said caller on said first IP phone;
transmitting, from said caller on said first IP phone to said call agent, a schedule for delivery of said recorded message to said second IP phone;
transmitting said recorded message to said second IP phone according to said schedule, wherein said call agent dials said second IP phone and plays out said recorded message upon said called party answering said second IP phone.

10. The method of claim 9, wherein said transmitting said signal comprises transmitting one of an audible or DTMF (Dual Tone Multi-Frequency) tones to said call agent.

11. The method of claim 9, wherein said transmitting a schedule for delivery comprises transmitting a command to said agent to perform a periodic transmission attempt of said recorded message to said second IP phone.

12. The method of claim 9, wherein said message is one of a voice or video message.

13. The method of claim 9, wherein said transmitting said recorded message further comprises:
playing said message out to said second IP phone upon said called party answering said IP phone; and
notifying said first IP phone of a delivery of said message to said second IP phone.

14. A system for delivery of messages over an packet network, comprising:
a network monitoring system for monitoring a packet network for network congestion between a first Internet Protocol (IP) phone, connected to said packet network, and a second IP phone, connected to said packet network;
a processor containing a call agent, wherein said call agent:
attempts a call between a caller on said first IP phone and a called party on said second IP phone;
notifies said caller that said packet network is unavailable to connect said call;
records a message, from said caller on said first IP phone, for delayed transmission to said second IP phone;
determines a connection on said packet network is available to transmit said recorded message to said second IP phone; and
dials said second IP phone and transmitting said message automatically to said second IP phone when said called party answers said second IP phone.

15. The system of claim 1, wherein said call agent transmits one of an audible or visual indicator signal to said first IP phone to notify said caller that said packet network is unavailable to connect said call.

16. The system of claim 14, wherein said call agent saves said message that is one of a voice or video message.

17. The system of claim 14, wherein said call agent on said processor further receives data from said monitoring system to said call agent that said packet network is available to place a call between said first IP phone and said second IP phone.
